(19) United States
(12) Patent Application Publication
(10) Pub. No.: US 2026/0301504 A1
(43) Pub. Date: Oct. 1, 2026

(54) ELECTRONIC GAMING SYSTEMS AND METHODS UTILIZING A HEXAGONAL ARRAY

(71) Applicant: Aristocrat Technologies, Inc., Las Vegas, NV (US)

(72) Inventors: Joseph Masinter, II, Las Vegas, NV (US); Alisa Mirabal, Henderson, NV (US); Bradley Hendricks, Las Vegas, NV (US); Alfred Thomas, Ventura, CA (US)

(21) Appl. No.: 19/094,149

(22) Filed: Mar. 28, 2025

(51) Int. Cl. G07F 17/32; G07F 17/34

(52) U.S. Cl. CPC G07F 17/3211; G07F 17/34

(57) ABSTRACT

An electronic gaming system is provided. The electronic gaming system may: (1) cause display of an interface including a plurality of primary positions arranged in a hexagonal matrix and a plurality of outer positions, each of the plurality of outer positions adjacent to one of the plurality of primary positions, wherein each of the positions is configured to display a symbol from a set of symbols; (2) generate, in each of the positions, a symbol from the set of symbols based on a first set of random number generator outcomes; (3) identify a first cluster within the plurality of primary positions, the first cluster including at least a threshold number of primary positions that are adjacent and each include a first symbol associated with a first value; and (4) determine a multiplier based on the first cluster being adjacent to at least one outer position including the first symbol.

### TECHNICAL FIELD

The field of disclosure relates generally to electronic gaming, and more specifically, to systems and methods that utilize a hexagonal array as a display interface.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system is provided. The electronic gaming system may include at least one memory with instructions stored thereon. The at least one memory may be further configured to store a set of symbols, each symbol of the set of symbols associated with a value. The electronic gaming system may further include at least one processor in communication with the at least one memory. The instructions, when executed by the at least one processor, may cause the at least one processor to: (1) cause display of an interface including a plurality of primary positions arranged in a hexagonal matrix and a plurality of outer positions, each of the plurality of outer positions adjacent to one of the plurality of primary positions, wherein each of the plurality of primary positions and each of the plurality of outer positions is configured to display a symbol from the set of symbols; (2) generate, in each of the plurality of primary positions and each of the plurality of outer positions, a symbol from the set of symbols based on a first set of random number generator outcomes; (3) identify a first cluster within the plurality of primary positions, the first cluster including at least a threshold number of primary positions that are adjacent and each include a first symbol associated with a first value; (4) determine a multiplier based on the first cluster being adjacent to at least one outer position including the first symbol; (5) compute an award amount based at least in part on the multiplier and the first value; and (6) credit the computed award amount to a player credit balance.

In another aspect, a method for electronic gaming is provided. The method may be performed by at least one processor in communication with at least one memory storing a set of symbols, each symbol of the set of symbols associated with a value. The method may include: (1) causing display of an interface including a plurality of primary positions arranged in a hexagonal matrix and a plurality of outer positions, each of the plurality of outer positions adjacent to one of the plurality of primary positions, wherein each of the plurality of primary positions and each of the plurality of outer positions is configured to display a symbol from the set of symbols; (2) generating, in each of the plurality of primary positions and each of the plurality of outer positions, a symbol from the set of symbols based on a first set of random number generator outcomes; (3) identifying a first cluster within the plurality of primary positions, the first cluster including at least a threshold number of primary positions that are adjacent and each include a first symbol associated with a first value; (4) determining a multiplier based on the first cluster being adjacent to at least one outer position including the first symbol; (5) computing an award amount based at least in part on the multiplier and the first value; and (6) crediting the computed award amount to a player credit balance.

In another aspect, at least one non-transitory computer-readable media having instructions embodied thereon is provided. When executed by at least one processor in communication with at least one memory storing a set of symbols, each symbol of the set of symbols associated with a value, the instructions may cause the at least one processor to: (1) cause display of an interface including a plurality of primary positions arranged in a hexagonal matrix and a plurality of outer positions, each of the plurality of outer positions adjacent to one of the plurality of primary positions, wherein each of the plurality of primary positions and each of the plurality of outer positions is configured to display a symbol from the set of symbols; (2) generate, in each of the plurality of primary positions and each of the plurality of outer positions, a symbol from the set of symbols based on a first set of random number generator outcomes; (3) identify a first cluster within the plurality of primary positions, the first cluster including at least a threshold number of primary positions that are adjacent and each include a first symbol associated with a first value; (4) determine a multiplier based on the first cluster being adjacent to at least one outer position including the first symbol; (5) compute an award amount based at least in part on the multiplier and the first value; and (6) credit the computed award amount to a player credit balance.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an exemplary process for electronic gaming according to an exemplary embodiment of the present disclosure.

FIG. 5A illustrates an exemplary game interface according to an exemplary embodiment of the present disclosure in a first state.

FIG. 5B illustrates the exemplary game interface shown in FIG. 5A in a second state.

FIG. 5C illustrates the exemplary game interface shown in FIGS. 5A and 5B in a third state.

FIG. 5D illustrates the exemplary game interface shown in FIGS. 5A, 5B, and 5C in a fourth state.

FIG. 6 illustrates an example reel structure according to an exemplary embodiment of the present disclosure.

FIG. 7 illustrates another example reel structure according to an exemplary embodiment of the present disclosure.

### DETAILED DESCRIPTION

Described herein are systems and methods for electronic gaming. The systems and methods described herein generate a display interface having a hexagonal matrix configuration.

In exemplary embodiments, an electronic gaming system may include at least one memory and at least one processor. The memory may be configured to record a current state of a game interface within a predefined data structure. As described in further detail below, this game interface may include a plurality of primary positions arranged in a hexagonal array and one or more outer positions that are located outside a perimeter of the hexagonal array and adjacent to a respective one of the primary positions. Each of the primary positions and outer positions may be configured to display a respective symbol selected from a predefined set of symbols. The predefined memory structure may include data that can be used to identify, for a given primary position, a symbol currently displayed in the given primary position and any other primary positions or outer positions that are adjacent to the given primary position.

The electronic gaming system may further include a cluster identifying component that may be executed by the processor. The processor may be configured to cause display the game interface including the plurality of primary positions and outer positions. For each game instance of an electronic game, the at least one processor may generate, in each of the plurality of primary positions and each of the plurality of outer positions, a symbol from the set of symbols based on a first set of random number generator outcomes. The resulting state of the game interface may be recorded in the memory using the predefined data structure.

The processor may execute the cluster identifying component, which may be configured to analyze the state recorded using the predefined data structure to identify clusters including at least a threshold number of adjacent primary positions (i.e., primary positions that are adjacent to at least one other primary position in the cluster) that are currently displaying the same symbol from the set of symbols. The cluster identifying component may be further configured to, for each of these identified clusters, determine if the cluster is adjacent to one or more outer positions that also are currently displaying the same symbol displayed in the primary positions of the cluster. These identifications and determinations output by the cluster identifying component may be used by the at least one processor to compute an award amount. In the exemplary embodiment, each symbol may be associated with a value. Accordingly, each cluster may result in an award determined based on the value of the symbol included in the cluster and other factors such as a number of primary positions included in the cluster. Additionally, a multiplier may be determined based on whether any of the clusters are adjacent to one or more outer positions that include the same symbol and other factors such as the number of clusters that are adjacent to one or more outer position including the same symbol, the number of outer positions having the same symbol that are adjacent to a particular cluster, and/or additional RNG outcomes. This multiplier may be applied across the values associated with all currently displayed clusters to determine the award amount.

A technical problem exists inherent in electric games including a cluster game mechanic, in that an occurrence of multiple clusters within a game may results in an expectation of a relatively high award outcome. If the award amount is computed based on a symbol and number of primary positions associated with each cluster, an award resulting from a display of multiple clusters with the same number of symbols would be less than an award resulting from a single cluster with the same number of symbols, which may result in disappointment when multiple clusters are displayed. In addition, changing how the value associated with each cluster is computed may result in increased computing complexity or memory requirements, as alternative schemes for computing the award amount may require additional computing steps, larger pay tables, and/or a need to store a greater number of pay tables. The systems and methods described herein solve this problem by applying a multiplier based on an output of the cluster identifying component. This multiplier may be used to adjust the award amount to reflect the probability of achieving a particular display outcome without requiring any change to the underlying cluster analysis.

Another technical problem exists in increasing variability and apparent randomness of display outcomes while maintaining understandability of the game to a user using a limited amount of display area and a predefined game layout (e.g., a matrix). The electronic described herein includes a great number of display elements that may be controlled based upon random determinations (e.g., using independent random number generator outcomes and lookup tables to determine symbols to display in the outer positions). These display elements include, for example, the symbols that are displayed in each of the outer positions, whether a multiplier is applied based on the symbols being displayed in the outer positions and primary positions, and a value of any multipliers that are applied. Accordingly, the system described herein solves this technical problem by increasing the randomness and/or variability of display outcomes that may be presented within a given display area and predefined game layout.

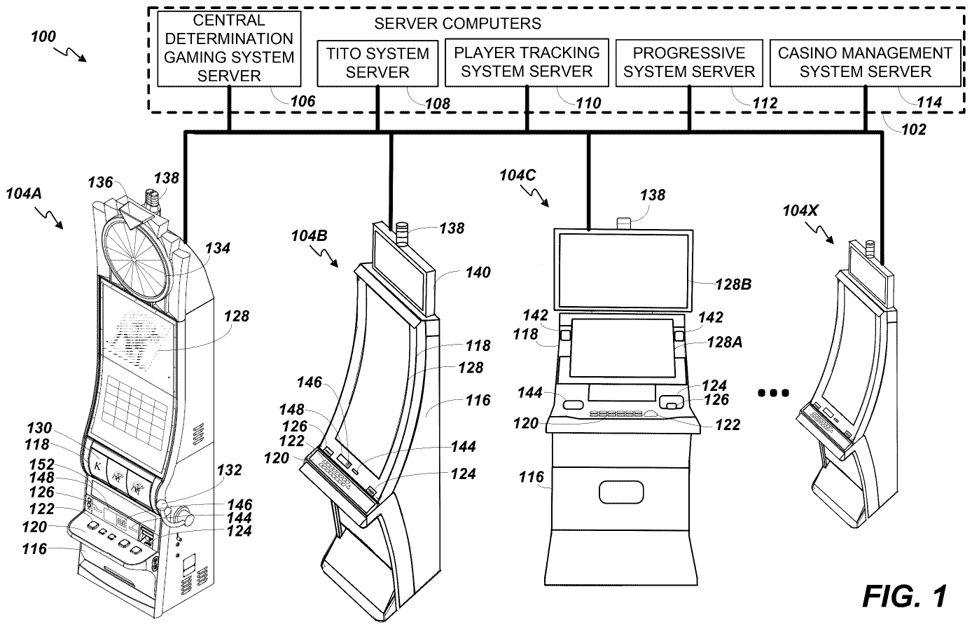

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

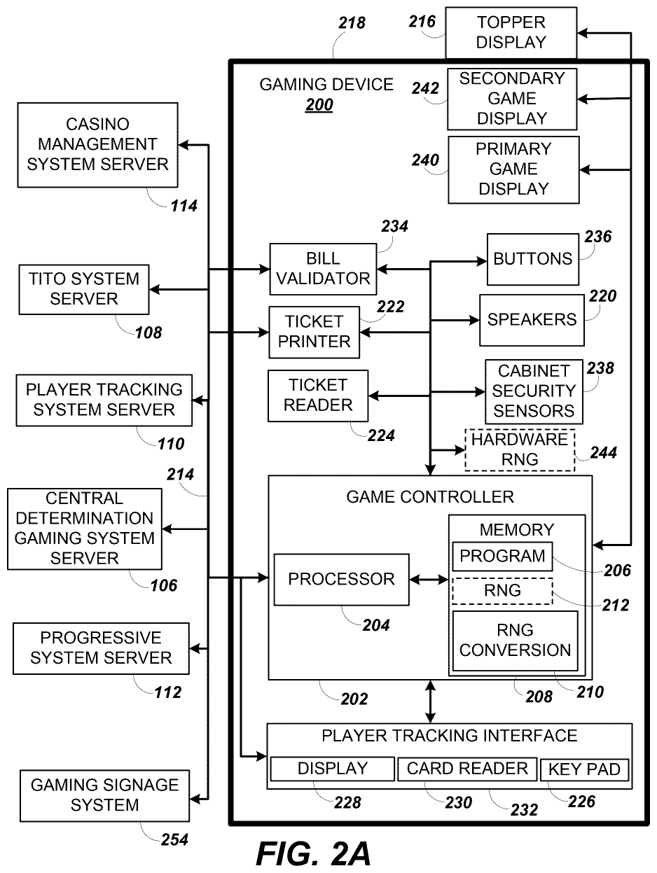

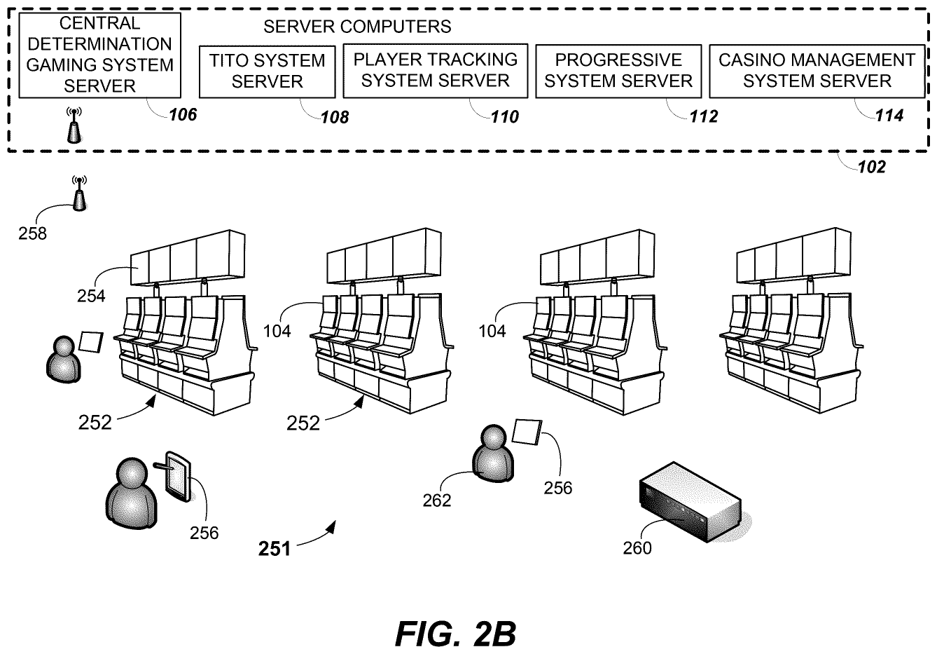

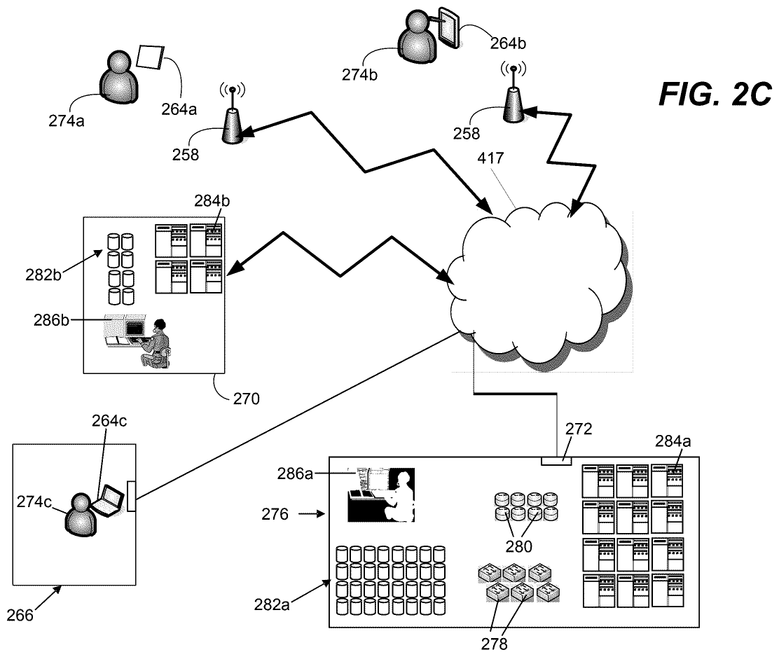

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

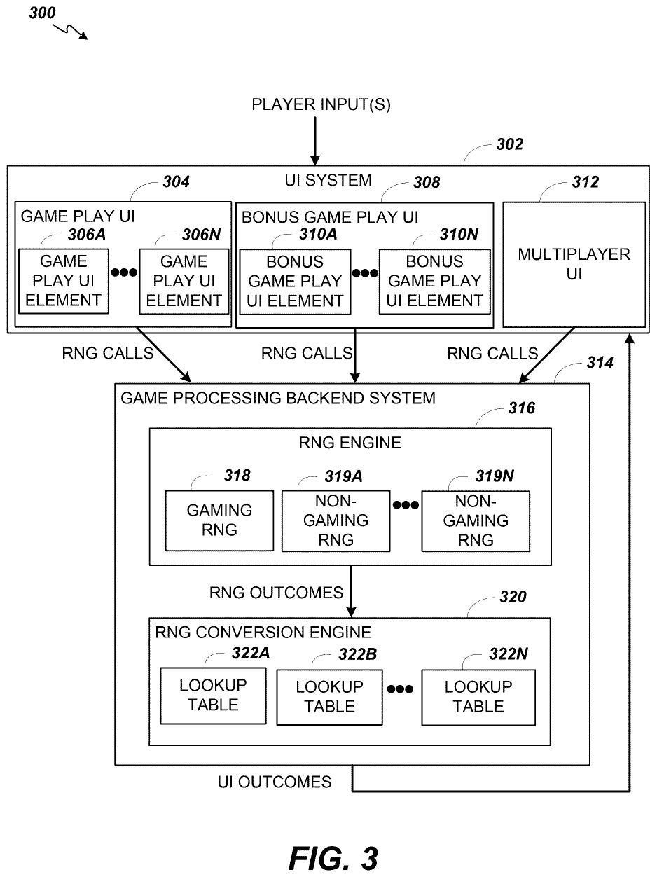

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

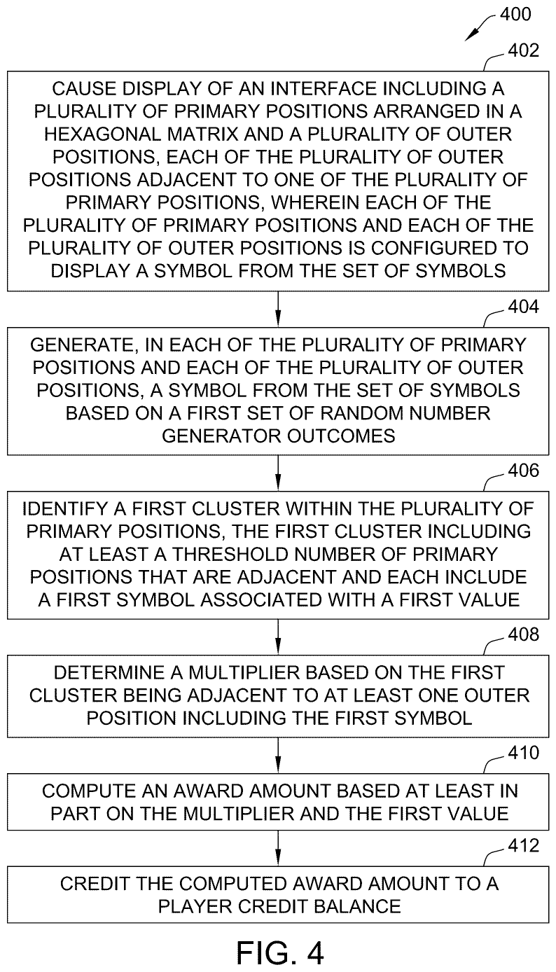

FIG. 4 is a flowchart illustrating an exemplary process 400 for evaluating and displaying an electronic game utilizing a hexagonal array accordance with an exemplary embodiment of the present disclosure. Process 400 may be performed, for example, by gaming devices 104A-104X, server 106 (shown in FIG. 1), mobile gaming devices 256 (shown in FIG. 2), or some combination thereof. Gaming devices 104A-104X, server 106, and/or mobile gaming devices 256 (shown in FIG. 2) may be configured to execute a cluster identifying component for identifying clusters of adjacent symbols within a predefined data structure.

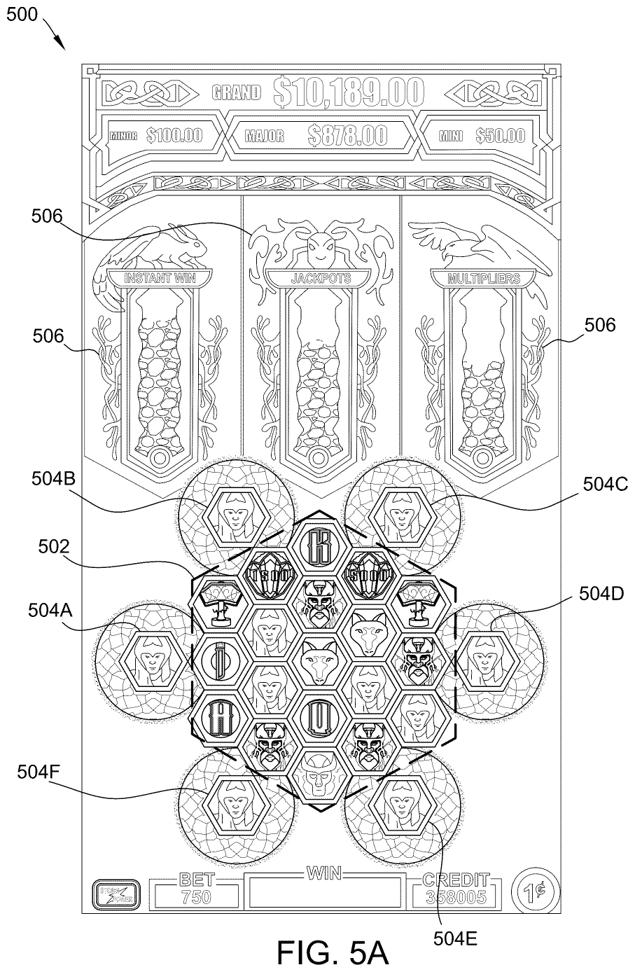

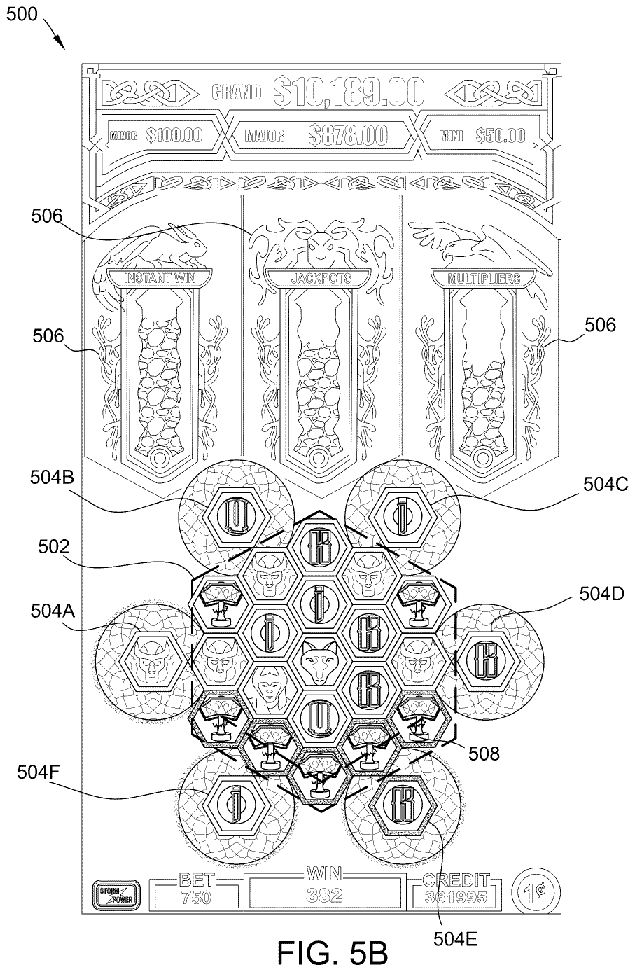

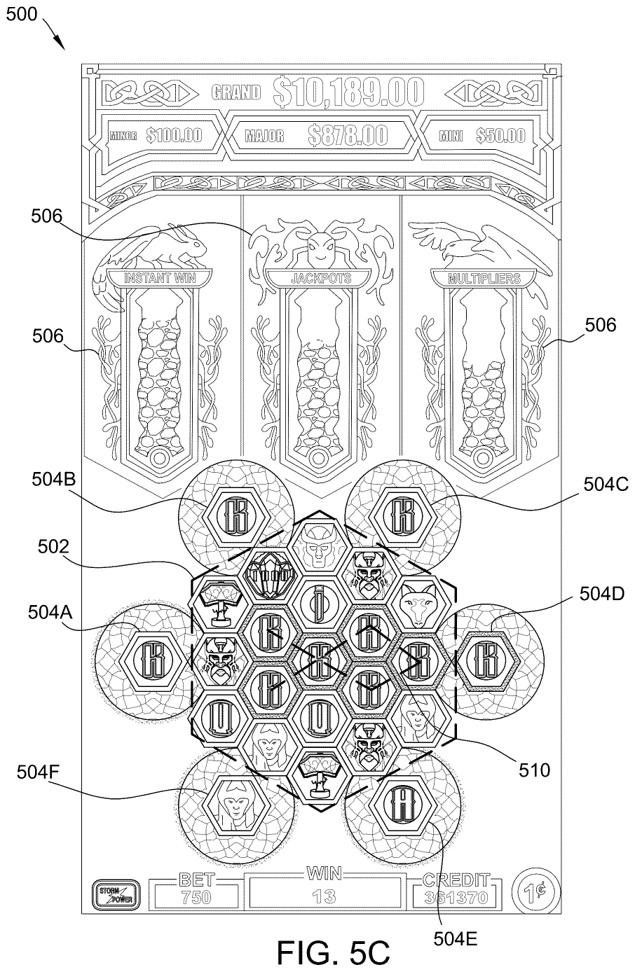

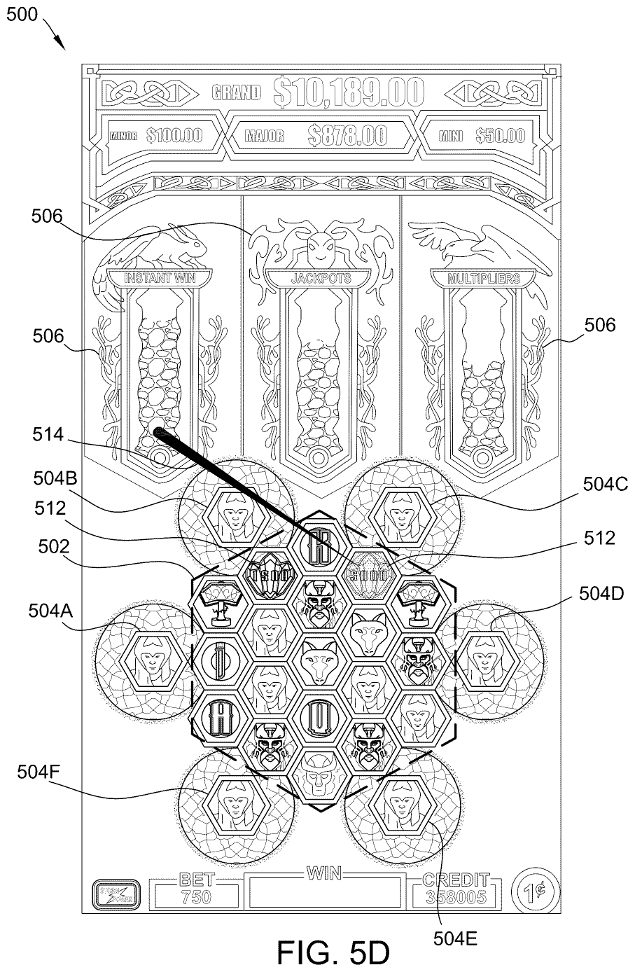

In the exemplary embodiment, process 400 may include causing 402 display of an interface including a plurality of primary positions arranged in a hexagonal matrix and a plurality of outer positions. As illustrated in further detail below with respect to FIGS. 5A-5D, each the plurality of outer positions may be adjacent to one of the plurality of primary positions. Each of the plurality of primary positions and each of the plurality of outer positions may be configured to display a symbol from a set of symbols.

Process 400 may further include generating 404, in each of the plurality of primary positions and each of the plurality of outer positions, a symbol from the set of symbols based on a first set of random number generator outcomes. A record of the symbol generated in each of each of the plurality of primary positions and each of the plurality of outer positions may be generated in memory 208. This record may have a predefined data structure that is interpretable by the cluster identifying component.

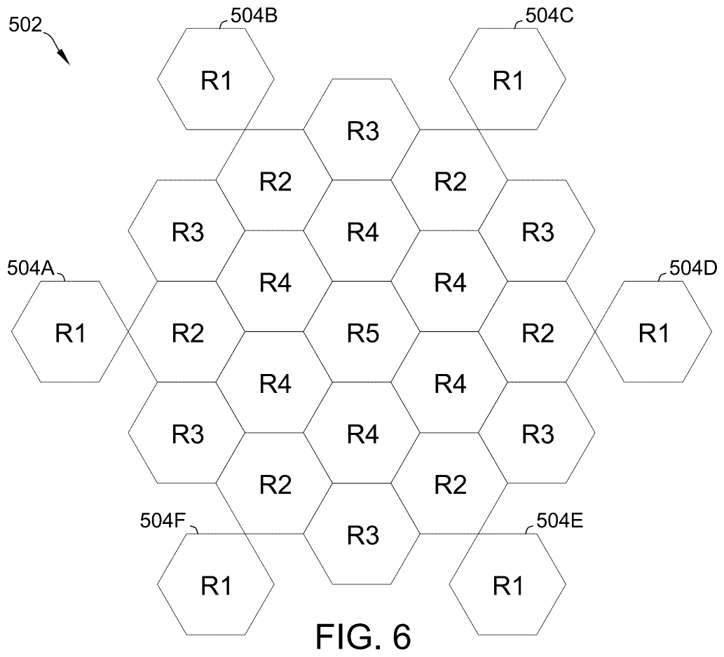

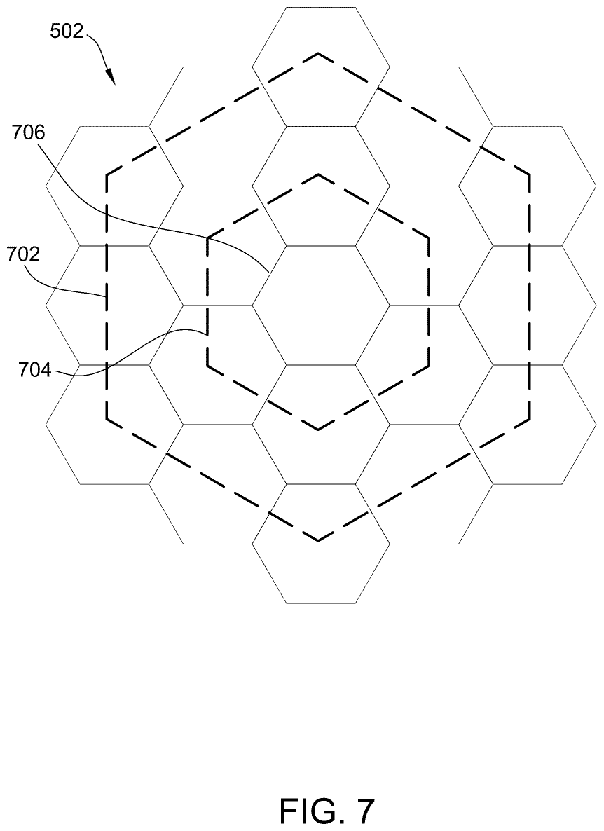

In certain embodiments, memory 208 may be configured to store a plurality of reels, each of the reels associated with one or more of the outer positions or with one or more of the primary the primary positions. To generate the symbol in in each of the plurality of primary positions and each of the plurality of outer positions, a stopping position of each of the plurality of reels and/or portion of each of the plurality of reels to be displayed may be determined based on the first set of random number generator outcomes. In some embodiments, each inner position and each outer position may be associated with its own reel. Alternatively, in some embodiments, a number of reels less than the total number of primary positions and outer positions (e.g., five reels) may be stored, and each of the primary positions and outer positions may be associated with one of the reels. Examples of such reel configurations are described in further detail below with respect to FIGS. 6 and 7. In other implementations, different groupings may be utilized.

Process 400 may further include identifying 406 at least a first cluster within the plurality of primary positions, for example, by executing the cluster identifying component to identify the first cluster based on the record stored in memory 208. The first cluster may include at least a threshold number of primary positions that are adjacent and each include a first symbol associated with a first value. In some cases, additional clusters may be identified within the within the plurality of primary positions. For example, a second cluster, also having the threshold number of primary positions, may be identified that has primary positions including a second symbol (different from the first symbol) associated with a second value or primary positions including the first symbol but are not adjacent to the primary positions of the first cluster. In other words, if the first cluster includes Symbol A, the second cluster may (1) be adjacent to the first cluster but include a different Symbol B, (2) include symbol A but not be adjacent to the first cluster, or (3) include Symbol B and not be adjacent to the first cluster.

Process 400 may further include determining 408 a multiplier based on the first cluster being adjacent to at least one outer position including the first symbol. In some embodiments, the multiplier may be determined based on a number of outer positions including the first symbol that are adjacent to the first cluster. For example, if the first cluster is adjacent to one outer position including the first symbol, a first multiplier may be determined, and if the first cluster is adjacent to two outer positions including the first symbol, a second multiplier higher than the first multiplier may be determined. In certain embodiments, other factors, such as the number of clusters identified, may be used to determine the multiplier. In some cases, an additional random determination based on an additional RNG output may be used to determine the multiplier or if the multiplier is applied. For example, a determination that a first cluster is adjacent to at least one outer position including the first symbol may trigger this additional random determination, which in turn may be used to determine the multiplier.

Process 400 may further include computing 410 an award amount based at least in part on the multiplier, the first value, and other values associated with any other identified clusters and crediting 412 the computed award amount to a player credit balance as described above. For example, an amount may be computed for each cluster based on the value associated with the symbol included in the cluster and the number of primary positions covered by the cluster. The determined multiplier may be applied to a sum of these amounts to determine the award amount.

FIGS. 5A-5D illustrate an exemplary game interface 500 that may be displayed, for example, by gaming devices 104A-104X and/or mobile gaming devices 256 (shown in FIG. 2) while executing process 400 (shown in FIG. 4) to present an electronic game.

FIG. 5A illustrates a first state of game interface 500 associated with a first example outcome of the electronic game. As shown in FIG. 5A, game interface 500 may include a plurality of primary positions 502 that are arranged into a hexagonal array in which each primary position 502 can be adjacent to up to six other primary positions 502. While FIG. 5A illustrates primary positions 502 as being hexagonal in shape, it should be appreciated that any shape capable of being arranged in a hexagonal array may be utilized. Additionally, while the hexagonal array formed by primary positions 502 is hexagonal in shape as a whole with nineteen total primary positions 502, it should be appreciated that primary positions may be arranged into a different shape with different numbers of primary positions 502 while still forming a hexagonal array.

Each primary position 502 is configured to display a respective symbol. For each instance of the electronic game, the symbol to display in each primary position 502 may be randomly selected, for example, by determining stopping positions for one or more reels based on one or more RNG outcomes. Each unique symbol may be associated with a respective value, which may be used to determine an award outcome of a game instance if a cluster of adjacent primary positions 502 including the same symbol is formed within the hexagonal array. In the exemplary embodiment, at least a threshold number of primary positions 502, such as five, must be included in such a cluster to result in an award. The award for a cluster may further depend on the number of primary positions 502 included in the cluster. For example, a cluster including six primary positions that include a first symbol may result in a greater award than a cluster including five primary positions that include the same first symbol. If more than one such cluster is displayed, each displayed cluster may result in a respective award. In the state of the electronic game illustrated in FIG. 5A, no such clusters are formed by primary positions 502.

As shown in FIG. 5A, game interface 500 further includes outer positions 504A-504F, each of which is positioned adjacent to one of the primary positions 502. Outer positions 504A-504F are configured to display a respective symbol, which may be selected from the same set of symbols that can be displayed in primary positions 502 or some subset thereof. Like primary positions 502, for each instance of the electronic game, the symbol to display in each outer position 504A-504F may be randomly selected, for example, by determining a stopping positions of a reel based on an RNG outcome. As described in further detail below, a multiplier may be triggered or determined based on one of outer positions 504A-504F displaying a symbol that is also displayed in an identified cluster of primary positions 502.

In certain embodiments, as shown in FIG. 5A, the electronic game may include additional features (e.g., metamorphic features), which may be triggered in response to outcomes of the electronic game, such as a display of certain symbols within primary positions 502, as described in further detail below with respect to FIG. 5D. These features may include various effects within the electronic games, such as jackpots, multipliers, and/or bonus games. Game interface 500 may include an indicator 506 corresponding to each of these features, which may change in appearance to indicate activation or potential activation of a feature.

FIG. 5B illustrates a second state of game interface 500 associated with a second example outcome of the electronic game. As shown in FIG. 5B, a cluster 508 may be formed by a group of at least five adjacent primary positions 502 (i.e., a group of primary positions 502 is adjacent to at least one other primary position 502 in the group) that display the same symbol. In alternative embodiments, a different threshold number of primary positions 502 may be used. When cluster 508 is identified, for example, using the cluster identifying component described above, an award associated with cluster 508 may be determined based on, for example, the symbol that is included in cluster 508 and/or the number of primary positions 502 that are included in cluster 508. As shown in FIG. 5B, cluster 508 is adjacent to outer positions 504E and 504F. However, because in this example state neither of outer positions 504E and 504F include the same symbol as cluster 508, no additional multiplier is triggered.

FIG. 5C illustrates a third state of game interface 500 associated with a third example outcome of the electronic game. As shown in FIG. 5C, a cluster 510 may be formed by a group of at least five adjacent primary positions 502 that display the same symbol. Like cluster 508 described above, when cluster 510 is identified, for example, using the cluster identifying component described above, an award associated with cluster 510 may be determined based on, for example, the symbol that is included in cluster 510 and/or the number of primary positions 502 that are included in cluster 510. As shown in FIG. 5C, cluster 510 is adjacent to outer position 504D. Because outer position 504D includes the same symbol as cluster 510, a multiplier may be triggered, which may be applied to the award associated with cluster 510. If any additional clusters were to be displayed, the multiplier may also be applied to the additional clusters even if the clusters do not include the same symbol as cluster 510 and/or are not adjacent to any of outer positions 504A-504F. In some embodiments, the multiplier may depend on a number of outer positions 504A-504F that are adjacent to a cluster. For example, if cluster 510 were to also be adjacent to another outer position in addition to outer position 504D, a greater multiplier may be applied.

FIG. 5D illustrates a fourth state of game interface 500 associated with a fourth example outcome of the electronic game. As shown in FIG. 5D, in some embodiments, the set of symbols that can be displayed in primary positions 502 may include triggering symbols 512. When a triggering symbol 512 is displayed, a corresponding game feature may be triggered and/or a random determination may be performed (e.g., based on an RNG outcome and table lookup) to determine whether to trigger the feature. As shown in FIG. 5D, when a triggering symbol 512 is displayed, an animation 514 may be displayed connecting the triggering symbol 512 to the corresponding indicator 506. In some embodiments, animation 514 may be displayed irrespective of whether the corresponding feature is actually triggered, and may be used to build user anticipation and/or to inform the user of the relationship between the displayed triggering symbol 512 and the corresponding indicator 506.

FIG. 6 is a diagram illustrating an exemplary reel structure that may be used to determine symbols to display in primary positions 502. As shown in FIG. 6, each one of primary positions 502 and outer positions 504A-504F are associated with one of five reels (R1, R2, R3, R4, and R5). Each of reels R1, R2, R3, R4, and R5 may include a sequence of symbols, and for each of group of primary positions 502 or outer positions 504A-504F that is associated with one of reels R1, R2, R3, R4, and R5, an RNG outcome may be used to randomly determine a stopping position or portion of each reel to be displayed within the corresponding group of primary positions 502 or outer positions 504A-504F.

FIG. 7 is a diagram illustrating another alternative exemplary reel structure that may be used to determine symbols to display in primary positions 502. As shown in FIG. 7, primary positions 502 may form a plurality of concentric groups including an outer group 702, a middle group 704, and a center position 706. Each one of outer group 702, middle group 704, and center position 706 may be associated with a respective reel stored in memory 208. Each of these reels may include a sequence of symbols, and for each of outer group 702, middle group 704, and center position 706, an RNG outcome may be used to randomly determine a stopping position or portion of each reel to be displayed within the corresponding group of primary positions 502.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
at least one memory with instructions stored thereon, the at least one memory further configured to store a set of symbols, each symbol of the set of symbols associated with a value; and
at least one processor in communication with the at least one memory, wherein the instructions, when executed by the at least one processor, cause the at least one processor to:
cause display of an interface including a plurality of primary positions arranged in a hexagonal matrix and a plurality of outer positions, each of the plurality of outer positions adjacent to one of the plurality of primary positions, wherein each of the plurality of primary positions and each of the plurality of outer positions is configured to display a symbol from the set of symbols;
generate, in each of the plurality of primary positions and each of the plurality of outer positions, a symbol from the set of symbols based on a first set of random number generator outcomes;
identify a first cluster within the plurality of primary positions, the first cluster including at least a threshold number of primary positions that are adjacent and each include a first symbol associated with a first value;
determine a multiplier based on the first cluster being adjacent to at least one outer position including the first symbol;
compute an award amount based at least in part on the multiplier and the first value; and
credit the computed award amount to a player credit balance.

2. The electronic gaming system of claim 1, further comprising a cluster identifying component configured to identify clusters of adjacent symbols within a predefined data structure, wherein the instructions further cause the at least one processor to:
generate a record in the at least one memory of the symbol generated in each of each of the plurality of primary positions and each of the plurality of outer positions, the record having the predefined data structure; and
execute the cluster identifying component to identify the first cluster based on the record.

3. The electronic gaming system of claim 1, wherein the instructions further cause the at least one processor to:
identify a second cluster within the plurality of primary positions, the second cluster including at least a threshold number of primary positions that are adjacent and each include a second symbol associated with a second value; and
compute the award amount further based on the second value.

4. The electronic gaming system of claim 1, wherein the instructions further cause the at least one processor to determine the multiplier based on a number of outer positions including the first symbol that are adjacent to the first cluster.

5. The electronic gaming system of claim 1, wherein the at least one memory is further configured to store a plurality of reels, each of the reels associated with one of the outer positions or with a subset of the primary positions, and wherein to generate the symbol in in each of the plurality of primary positions and each of the plurality of outer positions, wherein the instructions are further configured to cause the at least one processor to determine a stopping position of each of the plurality of reels based on the first set of random number generator outcomes.

6. The electronic gaming system of claim 1, wherein processor is further configured to determine the multiplier based on a number of clusters identified within the plurality of primary positions.

7. The electronic gaming system of claim 1, wherein the instructions are further configured to cause the at least one processor to compute the award amount by applying the multiplier to a sum of values associated with any identified clusters.

8. A method for electronic gaming performed by at least one processor in communication with at least one memory storing a set of symbols, each symbol of the set of symbols associated with a value, the method comprising:
causing display of an interface including a plurality of primary positions arranged in a hexagonal matrix and a plurality of outer positions, each of the plurality of outer positions adjacent to one of the plurality of primary positions, wherein each of the plurality of primary positions and each of the plurality of outer positions is configured to display a symbol from the set of symbols;
generating, in each of the plurality of primary positions and each of the plurality of outer positions, a symbol from the set of symbols based on a first set of random number generator outcomes;
identifying a first cluster within the plurality of primary positions, the first cluster including at least a threshold number of primary positions that are adjacent and each include a first symbol associated with a first value;
determining a multiplier based on the first cluster being adjacent to at least one outer position including the first symbol;
computing an award amount based at least in part on the multiplier and the first value; and
crediting the computed award amount to a player credit balance.

9. The method of claim 8, further comprising:
generating a record in the at least one memory of the symbol generated in each of each of the plurality of primary positions and each of the plurality of outer positions, the record having a predefined data structure; and
executing a cluster identifying component to identify the first cluster based on the record.

10. The method of claim 8, further comprising:
identifying a second cluster within the plurality of primary positions, the second cluster including at least a threshold number of primary positions that are adjacent and each include a second symbol associated with a second value; and
computing the award amount further based on the second value.

11. The method of claim 8, further comprising determining the multiplier based on a number of outer positions including the first symbol that are adjacent to the first cluster.

12. The method of claim 8, wherein the at least one memory is further configured to store a plurality of reels, each of the reels associated with one of the outer positions or with a subset of the primary positions, and wherein generating the symbol in in each of the plurality of primary positions and each of the plurality of outer positions comprises determining a stopping position of each of the plurality of reels based on the first set of random number generator outcomes.

13. The method of claim 8, further comprising determining the multiplier based on a number of clusters identified within the plurality of primary positions.

14. The method of claim 8, further comprising computing the award amount by applying the multiplier to a sum of values associated with any identified clusters.

15. At least one non-transitory computer-readable media having instructions embodied thereon, wherein when executed by at least one processor in communication with at least one memory storing a set of symbols, each symbol of the set of symbols associated with a value, the instructions cause the at least one processor to:
cause display of an interface including a plurality of primary positions arranged in a hexagonal matrix and a plurality of outer positions, each of the plurality of outer positions adjacent to one of the plurality of primary positions, wherein each of the plurality of primary positions and each of the plurality of outer positions is configured to display a symbol from the set of symbols;
generate, in each of the plurality of primary positions and each of the plurality of outer positions, a symbol from the set of symbols based on a first set of random number generator outcomes;
identify a first cluster within the plurality of primary positions, the first cluster including at least a threshold number of primary positions that are adjacent and each include a first symbol associated with a first value;
determine a multiplier based on the first cluster being adjacent to at least one outer position including the first symbol;
compute an award amount based at least in part on the multiplier and the first value; and
credit the computed award amount to a player credit balance.

16. The non-transitory computer-readable media of claim 15, wherein the instructions further cause the at least one processor to:
generate a record in the at least one memory of the symbol generated in each of each of the plurality of primary positions and each of the plurality of outer positions, the record having a predefined data structure; and
execute a cluster identifying component to identify the first cluster based on the record.

17. The non-transitory computer-readable media of claim 15, wherein the instructions further cause the at least one processor to:
identify a second cluster within the plurality of primary positions, the second cluster including at least a threshold number of primary positions that are adjacent and each include a second symbol associated with a second value; and
compute the award amount further based on the second value.

18. The non-transitory computer-readable media of claim 15, wherein the instructions further cause the at least one processor to determine the multiplier based on a number of outer positions including the first symbol that are adjacent to the first cluster.

19. The non-transitory computer-readable media of claim 15, wherein the at least one memory is further configured to store a plurality of reels, each of the reels associated with one of the outer positions or with a subset of the primary positions, and wherein to generate the symbol in in each of the plurality of primary positions and each of the plurality of outer positions, wherein the instructions are further configured to cause the at least one processor to determine a stopping position of each of the plurality of reels based on the first set of random number generator outcomes.

20. The non-transitory computer-readable media of claim 15, wherein the instructions further cause the at least one processor determine the multiplier based on a number of clusters identified within the plurality of primary positions.
